(19) United States
(12) Patent Application Publication
(10) Pub. No.: US 2018/0308333 A1
(43) Pub. Date: Oct. 25, 2018

(54) ANTI-COLLISION SYSTEM

(71) Applicants: Mary BRADY, Northport, NY (US); Brian CARCHEDI, Mansfield, MA (US); Stephen POLAY, Wayne, NJ (US); Joshua McCAWLEY, East Brunswick, NJ (US)

(72) Inventors: Mary BRADY, Northport, NY (US); Brian CARCHEDI, Mansfield, MA (US); Stephen POLAY, Wayne, NJ (US); Joshua McCAWLEY, East Brunswick, NJ (US)

(21) Appl. No.: 15/957,512

(22) Filed: Apr. 19, 2018

Related U.S. Application Data
(60) Provisional application No. 62/487,243, filed on Apr. 19, 2017.

(51) Int. Cl. G08B 21/02; A63B 71/08; A63B 71/00

(52) U.S. Cl. CPC G08B 21/02; H04W 4/80; A63B 71/0054; A63B 71/08

(57) ABSTRACT

An anti-collision system configured for use in a ballpark is provided. The anti-collision system includes a first device that is configured for short range wireless communication and that is configured to be worn by a ballplayer, and a second device that is configured for short range wireless communication with the first device and being located on at least one of a wall of the ballpark, a dugout of the ballpark, and another ballplayer. When a distance between the first device and the second device is less than or equal to a predetermined distance, the first device is configured to provide an alert to the ballplayer, thereby preventing a collision between the ballplayer and one of the wall of the ballpark, the dugout of the ballpark, and the another ballplayer.

### PRIORITY

The present application claims priority under 35 U.S.C. §119(e) to U.S. Provisional Patent Application Ser. No. 62/487,243, which was filed on Apr. 19, 2017, the entire disclosure of which is incorporated herein by reference.

### BACKGROUND

### 1. Field of the Disclosure

The present disclosure relates, generally, to an anti-collision system, and more particularly, to an anti-collision system including multiple wireless communication devices, at least one of which is configured to be worn by a user.

### 2. Description of the Related Art

Sports related injuries due to collisions between an athlete and another athlete (or an athlete and a boundary, e.g., a wall, fence, dug-out, or other obstruction) are common. For example, in baseball it is all too common for an outfielder to collide with another player (or outfield fence) when attempting to field a ball.

### SUMMARY

In view of the above, an anti-collision system including multiple wireless communication devices, at least one of which is configured to be worn by a user, may prove advantageous in amateur and professional sports.

In accordance with an aspect of the present disclosure, there is provided an anti-collision system configured for use in a ballpark. The anti-collision system includes a first device configured for short range wireless communication and configured to be worn by a ballplayer and a second device configured for short range wireless communication with the first device and being located on at least one of a wall of the ballpark, a dugout of the ballpark, and another ballplayer, such that when a distance between the first device and the second device is less than or equal to a predetermined distance, the first device is configured to provide an alert to the ballplayer, thereby preventing a collision between the ballplayer and one of the wall of the ballpark, the dugout of the ballpark, and the another ballplayer.

In accordance with an aspect of the present disclosure, there is provided a method of use of an anti-collision system for preventing a collision between a ballplayer and at least one of a wall of a ballpark, a dugout of the ballpark, and another ballplayer. The method includes using a first device configured for short range wireless communication and configured to be worn by a ballplayer and using a second device configured for short range wireless communication with the first device and being located on at least one of a wall of the ballpark, a dugout of the ballpark, and another ballplayer, such that when a distance between the first device and the second device is less than or equal to a predetermined distance, the first device is configured to provide an alert to the ballplayer, thereby preventing a collision between the ballplayer and one of the wall of the ballpark, the dugout of the ballpark, and the another ballplayer.

In accordance with an aspect of the present disclosure, there is provided a non-transitory computer readable storage medium having stored thereon a plurality of instructions that when executed perform a method for preventing a collision between a ballplayer and at least one of a wall of a ballpark, a dugout of the ballpark, and another ballplayer. The method includes using a first device configured for short range wireless communication and configured to be worn by a ballplayer and using a second device configured for short range wireless communication with the first device and being located on at least one of a wall of the ballpark, a dugout of the ballpark, and another ballplayer, such that when a distance between the first device and the second device is less than or equal to a predetermined distance, the first device is configured to provide an alert to the ballplayer, thereby preventing a collision between the ballplayer and one of the wall of the ballpark, the dugout of the ballpark, and the another ballplayer.

In accordance with an aspect of the present disclosure, there is provided an anti-collision system configured for use by a user. The anti-collision system includes a first device configured for short range wireless communication and configured to be worn by the user and a second device configured for short range wireless communication with the first device and being located on at least one structure and another user, such that when a distance between the first device and the second device is less than or equal to a predetermined distance, the first device is configured to provide an alert to the user, thereby preventing a collision between the user and the at least one structure and another user.

### BRIEF DESCRIPTION OF THE DRAWINGS

Various embodiments of the present disclosure are described hereinbelow with reference to the drawings, in which:

FIG. 1 is diagram of an anti-collision system including an adaptive band, in accordance with an embodiment of the present disclosure;

FIG. 2 is a diagram of the anti-collision system of FIG. 1 used in a ballpark; and

FIG. 3 is a flowchart of a method of use of the anti-collision system for preventing a collision between a ballplayer and at least one of a wall of a ballpark, a dugout of the ballpark, and another ballplayer.

### DETAILED DESCRIPTION

Various embodiments of the present disclosure will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

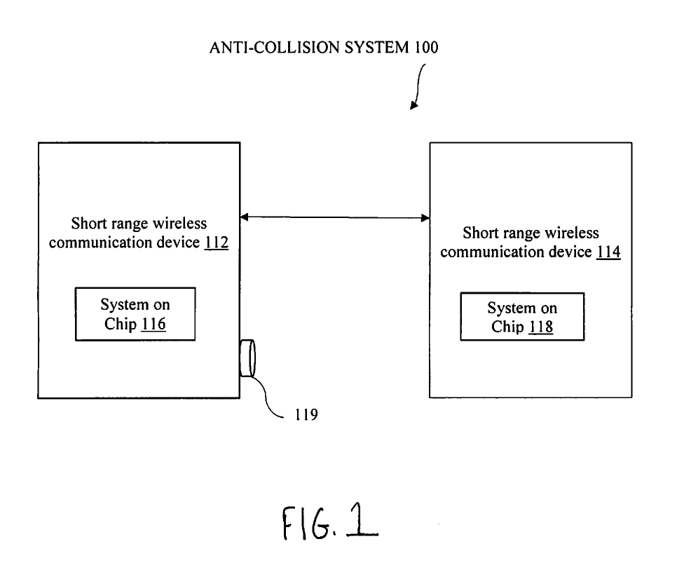

With reference to FIG. 1, an anti-collision system 100 including a first device 112 and a second device 114 is shown. The first device 112 and the second device 114 can communicate with each other via one or more short range wireless communication protocols, and when the anti-collision system 100 includes multiple first devices 112 and second devices 114, the multiple first devices 112 can communicate with each other and the multiple second devices 114, and vice-versa.

Wireless Fidelity (Wi-Fi), Bluetooth (BT), BT Low Energy (BLE), Near Field Communication (NFC), ZigBee, Magnetic Secure Transmission (MST), or other short range wireless communication protocols may be used in the first device 112 and the second device 114. Alternatively or additionally, the first device 112 and the second device 114 can also use one or more long range wireless communication protocols including, but not limited to, Long-Term Evolution (LTE), LTE Advance (LTE-A), Code Division Multiple Access (CDMA), Wideband

CDMA (WCDMA), Universal Mobile Telecommunications System (UMTS), Wireless Broadband (WiBro), and Global System for Mobile Communication (GSM).

While each of the above-referenced short (and long) range wireless communication protocols can provide a suitable wireless communication environment, since the short range wireless communication protocols, e.g., BLE, are relatively inexpensive and easy to configure, it will be assumed that the anti-collision system 100 operates using BLE.

In accordance with BLE, each of the first device 112 and the second device 114 can include, inter alia, a transmitter, receiver, transceiver, transponder, a processor, respectively, one or more BT/BLE module(s), one or more sensor modules (including an accelerometer), one or more antennas, memory, a bus, an input/output interface, a display, a communication interface, software and/or a program (which can be stored in the memory), a kernel, middleware, an application programming interface, and/or application programs.

The components of the first device 112 and second device 114 can be provided as separate modules on these devices, or they can be provided on a System on Chip (SoC) 116/118, as shown in FIG. 1. The processor controls the individual modules on the SoCs 116/118 of the first device 112 and the second device 114, respectively, thereby allowing these devices to function as described herein.

The first device 112 can be worn by a ballplayer and can be provided on an adaptive band, such as a watchband, which can be made from one or more suitable materials including plastics, elastomers, metals (e.g., surgical-grade stainless steel), metal alloys, etc., or the first device 112 can be included in one or more fitness tracker devices, e.g., XBAND™, Fitbit™, InvenSense™, Metawear™, CPRO™, Super Compact BLE Module™, and Motiv Ring™, or other fitness tracker device(s), which are configured for use with BT or BLE wireless communication protocols. The first device 112 can also be included in one or more smartwatches, e.g., Samsung Gear®, Apple Watch®, Garland Watch®, etc., or other smart device(s).

Moreover, the first device 112 can be provided on a hat of the ballplayer, eyeglasses or sunglasses of the ballplayer, jewelry of the ballplayer, and clothing or other apparel worn by the ballplayer.

In addition to communicating with the second device 114, a first device 112 that is worn by one ballplayer can communicate with another first device 112 that is worn by another ballplayer. Thus, each ballplayer can have their own first device 112. For example, a first device 112 that is included in an adaptive band worn by one ballplayer can communicate with another first device 112 that is included (woven into) in an elbow sleeve that is worn by another ballplayer. This is merely an example, and the present disclosure is no so limited.

The second device 114 is substantially similar (or in some instances identical) to the first device 112; however, the second device 114, as described herein, is not configured to be worn by a user, and is not configured to provide an alert to a user; although, it is contemplated that it could be worn by a user, in which case it would be identical to the first device 112. The second device can be affixed to or located on a wall of the ballpark (e.g., outfield wall, wall extending from behind the dugout and along the baselines up to the outfield wall), located in a dugout of the ballpark, or other area of the ballpark that may cause harm or injury to a ballplayer if the ballplayer were to collide with it.

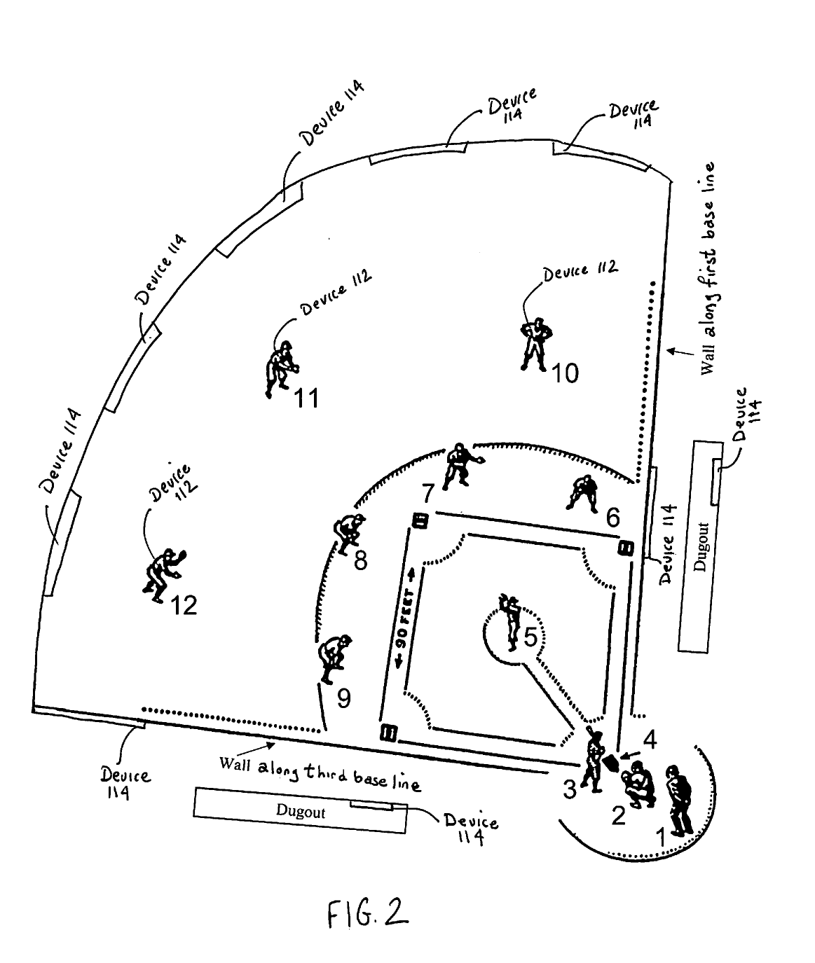

Depending on the short (or long) range wireless communication protocol used by the second device 114 (and/or the first device 112), one or more second devices 114 can be provided on or in one or more of the above areas of the ballpark. For example, a plurality of second devices 114 can be affixed to the outfield wall at certain intervals, the wall extending from behind the dugout and along the baselines up to the outfield wall at certain intervals, and in each of the dugouts of the ballpark (see FIG. 2, for example) at a central location or at certain intervals, depending on a size of the dugout.

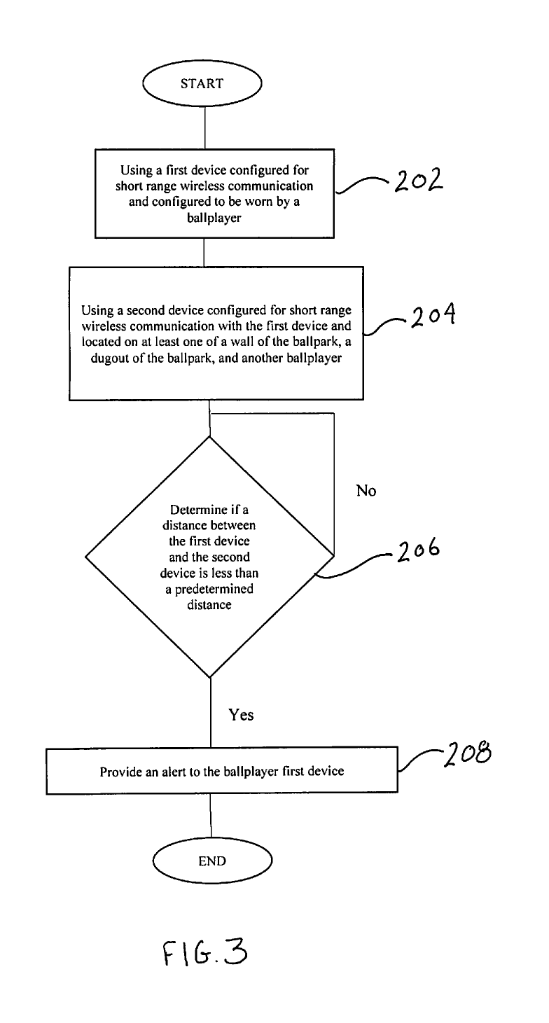

A method of use of the anti-collision system 100 is now described herein with reference to FIGS. 2 and 3. For illustrative purposes, it is assumed that each of an outfielder 10, outfielder 11, and outfielder 12 is provided with the first device 112; however, all the players 1-10 on the team can be provided with a first device 112. For example, the outfielder 10 can wear an adaptive band that includes the first device 112, the outfielder 11 can wear a ring that includes the first device 112, and the outfielder 12 can wear sunglasses that include the first device 112 (step 202).

Prior to taking the field, the first devices 112 on each of the outfielders 10-12 can be automatically synchronized with each other and/or with the second devices 114 that are provided on/in the designated areas of the ballpark. For example, when the first devices 112 come within a predetermined distance from one another, these devices can automatically be synchronized and stay synchronized with each other, in accordance with BLE.

The first devices 112 and the second devices 114 can be synchronized with each other in a similar fashion. More particularly, the first devices 112 can be synchronized with any one of the second devices 114 that are located throughout the ballpark. For example, the outfielder 10 can synchronize his first device 112 with a second device 114 that is located in the dugout; the outfielder 11 can synchronize his first device 112 with a second device 114 that is located on the wall extending among the third base line (e.g., as he takes the field); and the outfielder 12 can synchronize his first device 112 with a second device 114 that is affixed to the outfield wall (e.g., as he is practicing in the outfield) (step 204).

Once the first device 112 is synchronized to one of the second devices 114, that first device 112 is automatically synchronized with all of the second devices 114 that are located in the ballpark, as the second devices 114 are configured to communicate with each other, similar to a mesh network.

During play of the ballgame, if a hit ball draws, for example, the outfielder 12 toward the left outfield wall, when a distance between the outfielder 12 and the outfield wall is less than or equal to a predetermined distance, e.g., 5 feet to 20 feet (step 206), the processor on the SoC 118 of the second device 114 causes the second device 114 to transmit a control signal to the first device 112 on the sunglasses of the outfielder 12. Reception of the control signal at the first device 112 causes the processor on the SoC 116 of the first device 112 to provide an alert to the outfielder 12 (step 208).

For example, an auditory alert and/or a vibratory alert (or combination thereof) can be emitted from the first device 112 to alert the ballplayer 12 that they are approaching the left outfield wall. In the former scenario, a speaker of the sunglasses can emit audio to alert the outfielder 12 that they are approaching the left outfield wall, and in the latter scenario, a motor of the sunglasses can vibrate the sunglasses to similarly indicate to the outfielder 12 that they are approaching the left outfield wall. The first device 112 can be configured such that as the outfielder 12 gets closer to the left outfield wall (or the other designated areas that include the second device 114), the alert can increase in intensity. For example, a volume of the audio can become louder and/or a frequency of the vibrations can become higher as a distance between the outfielder 12 and the left outfield wall decreases, e.g., decreases from 20 feet to 5 feet.

In another example, if a hit ball draws the outfielder 12 and the outfielder 11 toward each other, the processors of the SoCs 116 of the first devices 112 on the ring of the outfielder 11 and the sunglasses of the outfielder 12, respectively, are configured to determine when a distance between the outfielder 11 and the outfielder 12 is less than or equal to the predetermined distance, e.g., 5 feet to 20 feet (or a different predetermined distance). When it is determined that the distance between the outfielder 11 and the outfielder 12 is less than or equal to the predetermined distance, their respective first devices 112 provide an alert to each of the outfielders 11 and 12.

Once the outfielder 11 and outfielder 12 are at a distance that is greater than the predetermined distance, their respective first devices 112 will automatically reset to a ready mode. Alternatively or additionally, an on/off button and/or a reset button 119 (FIG. 1) can be provided on the first devices 112 and can be used to allow the ballplayers to manually turn the first devices 112 on/off or can be used to manually reset the first devices 112.

With respect to the automatic shutoff, the accelerometer (or other suitable device) provided in the sensor module on the SoC 116 can be used to detect a speed of a ballplayer relative to the dugout, outfield wall, walls along the first and third base lines, another ballplayer, etc., so that, for example, if the ballplayer(s) is approaching the dugout at a relatively high speed, such as by running, second device 114 of the anti-collision system 100 will know to emit an alert, and if the ballplayer is approaching the dugout at a relatively low speed, such as by jogging or walking, the second device 114 will know not to emit an alert.

The anti-collision system 100 provides an additional level of safety for a ballplayer, e.g., outfielders, infielders, pitchers, and catchers. With the anti-collision system 100, ballplayers will have a better understanding of how close they are to a wall, fence, other ballplayers, dugouts, and/or other obstructions, when attempting to field balls. That is, the anti-collision system 100 provides a “safety net” for ballplayers, and can prevent serious injuries from occurring, e.g., concussions, fractures, tears, etc. The anti-collision system 100 provides a ballplayer with a better sense of where they are on the field, and by eliminating collisions, the anti-collision system 100 ensures players' safety throughout a season, thereby allowing them to have a more productive season.

From the foregoing and with reference to the various drawings, those skilled in the art will appreciate that certain modifications can also be made to the present disclosure without departing from the scope of the same. For example, first device 112 can be configured to detect when the ballplayers are in between innings and go into a sleep or disable mode, so alerts are not emitted when the ballplayers are headed into the dugout or are in the dugout.

Moreover, the second device 114 that is located in the dugout can be configured to automatically and temporarily disable the first devices 112 when the ballplayers are located in the dugout, and can automatically reset the first devices 112 when they are leaving the dugout to take the field.

As can be appreciated, the predetermined distance between two or more ballplayers (and a ballplayer and an object that has the second device 114 provided thereon/therein) can be less than 5 feet and/or greater than 20 feet.

Furthermore, a safety mechanism can be provided in the first devices 112 (and/or the second devices 114). More particularly, in the instance where two ballplayers are running towards one another, if one of the first devices 112 determines that the other first device 112 is not operable (e.g., left off unintentionally, broken, etc.), the operable first device 112 can be configured to automatically emit an audio alert to warn the ballplayer with the inoperable first device that he is approaching another ballplayer.

Additionally, while the anti-collision system 100 has been described herein for use in a ballpark and with a ballplayer, the present disclosure is not so limited. For example, the anti-collision system 110 can be used with other sports, including, but not limited to, hunting, racecar driving, boating, or any other sports/events where accidental collisions or contact can sometimes occur, or when it is imperative to know where other users/participants of the sport are located, e.g., hunters.

In accordance with the instant disclosure, a non-transitory computer readable storage medium (e.g., the memory on the SoC) can have stored thereon a plurality of instructions (software) that when executed perform a method for preventing a collision between a ballplayer and at least one of a wall of a ballpark, a dugout of the ballpark, and another ballplayer. The method includes using a first device configured for short range wireless communication and configured to be worn by a ballplayer, and using a second device configured for short range wireless communication with the first device and being located on at least one of a wall of the ballpark, a dugout of the ballpark, and another ballplayer, such that when a distance between the first device and the second device is less than or equal to a predetermined distance, the first device is configured to provide an alert to the ballplayer, thereby preventing a collision between the ballplayer and one of the wall of the ballpark, the dugout of the ballpark, and the another ballplayer.

For example, the software (e.g., an “app”) can be downloaded from a server and installed on one of the aforementioned first devices and second devices, or other client device(s). Firmware updates and other data can be automatically downloaded via the server.

While the present disclosure has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. An anti-collision system configured for use in a ballpark, the anti-collision system comprising:
a first device configured for short range wireless communication and configured to be worn by a ballplayer; and
a second device configured for short range wireless communication with the first device and being located on at least one of a wall of the ballpark, a dugout of the ballpark, and another ballplayer, such that when a distance between the first device and the second device is less than or equal to a predetermined distance, the first device is configured to provide an alert to the ballplayer, thereby preventing a collision between the ballplayer and one of the wall of the ballpark, the dugout of the ballpark, and the another ballplayer.

2. The anti-collision system of claim 1, wherein the first device is provided on one of a watchband of the ballplayer, a hat of the ballplayer, eyeglasses or sunglasses of the ballplayer, jewelry of the ballplayer, and clothing or other apparel worn by the ballplayer.

3. The anti-collision system of claim 1, wherein the alert is one of an auditory alert, a vibratory alert, and combination thereof.

4. The anti-collision system of claim 1, wherein the first device and the second device are configured to automatically synchronize with one another.

5. The anti-collision system of claim 1, wherein, when a distance between the first device and the second device is less than the predetermined distance, the alert provided to the ballplayer incrementally increases as the distance between the ballplayer and the one of the wall of the ballpark, the dugout of the ballpark, and the another ballplayer decreases.

6. The anti-collision system of claim 1, wherein after the alert is provided to the ballplayer and when the distance between the first device and the second device subsequently becomes greater than the predetermined distance, the first device automatically resets to a ready mode.

7. The anti-collision system of claim 1, wherein the first device includes an accelerometer that is configured to detect a speed of the first device such that when the distance between the first device and the second device is less than or equal the predetermined distance and the speed of the ballplayer exceeds a predetermined threshold, the first device is configured to provide the alert to the ballplayer.

8. The anti-collision system of claim 1, wherein the first device includes an on/off switch.

9. The anti-collision system of claim 1, wherein, when the second device is located in the dugout of the ballpark, it is configured to automatically shut off the first device when the ballplayer of the first device.

10. The anti-collision system of claim 1, wherein, when the second device is worn by the another ballplayer, the second device is identical to the first device, and when the second device is located at least on the wall of the ballpark and in the dugout of the ballpark, the second device is different from the first device.

11. A method of use of an anti-collision system for preventing a collision between a ballplayer and at least one of a wall of a ballpark, a dugout of the ballpark, and another ballplayer, the method comprising:
using a first device configured for short range wireless communication and configured to be worn by a ballplayer; and
using a second device configured for short range wireless communication with the first device and being located on at least one of a wall of the ballpark, a dugout of the ballpark, and another ballplayer, such that when a distance between the first device and the second device is less than or equal to a predetermined distance, the first device is configured to provide an alert to the ballplayer, thereby preventing a collision between the ballplayer and one of the wall of the ballpark, the dugout of the ballpark, and the another ballplayer.

12. The method of claim 11, further comprising providing the first device on one of a watchband of the ballplayer, a hat of the ballplayer, eyeglasses or sunglasses of the ballplayer, jewelry of the ballplayer, and clothing or other apparel worn by the ballplayer.

13. The method of claim 11, wherein the alert is provided using one of an auditory alert, a vibratory alert, and combination thereof.

14. The method of claim 11, further comprising automatically synchronizing the first device and the second device with one another.

15. The method of claim 11, further comprising, when a distance between the first device and the second device is less than the predetermined distance, incrementally increasing the alert provided to the ballplayer as the distance between the ballplayer and the one of the wall of the ballpark, the dugout of the ballpark, and the another ballplayer decreases.

16. The method of claim 11, further comprising, after the alert is provided to the ballplayer and when the distance between the first device and the second device subsequently becomes greater than the predetermined distance, automatically resetting the first device to a ready mode.

17. The method of claim 11, further comprising detecting a speed of the first device, by an accelerometer, such that when the distance between the first device and the second device is less than or equal to the predetermined distance and the speed of the ballplayer exceeds a predetermined threshold, the first device is configured to provide the alert to the ballplayer.

18. The method of claim 11, further comprising, when the second device is located in the dugout of the ballpark, using the second device for automatically shutting off the first device when the ballplayer of the first device is located in the dugout of the ballpark.

19. The method of claim 11, wherein, when the second device is worn by the another ballplayer, the second device is identical to the first device, and when the second device is located at least on the wall of the ballpark and in the dugout of the ballpark, the second device is different from the first device.

20. A non-transitory computer readable storage medium having stored thereon a plurality of instructions that when executed perform a method for preventing a collision between a ballplayer and at least one of a wall of a ballpark, a dugout of the ballpark, and another ballplayer, the method comprising:
using a first device configured for short range wireless communication and configured to be worn by a ballplayer; and
using a second device configured for short range wireless communication with the first device and being located on at least one or a wall of the ballpark, a dugout of the ballpark, and another ballplayer, such that when a distance between the first device and the second device is less than or equal to a predetermined distance, the first device is configured to provide an alert to the ballplayer, thereby preventing a collision between the ballplayer and one of the wall of the ballpark, the dugout of the ballpark, and the another ballplayer.
